(19) United States
(12) Patent Application Publication
(10) Pub. No.: US 2025/0085385 A1
(43) Pub. Date: Mar. 13, 2025

(54) RADAR SENSOR FOR DISTANCE DETERMINATION

(71) Applicant: BAUMER ELECTRIC AG, FRAUENFELD (CH)

(72) Inventors: RAINER MAUCH, HILZINGEN (DE); SOEREN ZINT, IMMENSTAAD (DE); FABIAN ILLI, BIRCHWIL (CH); FELIX HUBER, DONAUESCHINGEN (DE)

(73) Assignee: BAUMER ELECTRIC AG, FRAUENFELD (CH)

(21) Appl. No.: 18/830,603

(22) Filed: Sep. 11, 2024

(30) Foreign Application Priority Data
Sep. 12, 2023 (EP) 23196947.8

(51) Int. Cl. G01S 7/03; G01S 13/08; G01S 13/931

(52) U.S. Cl. CPC G01S 7/032; G01S 7/038; G01S 13/08; G01S 13/931

(57) ABSTRACT

A radar sensor includes a transmitter module, a receiver module, and a lens device. The transmitter module has a transmitter-side patch array antenna and transmits radar signals with a first directivity. The receiver module has a receiver-side patch array antenna and receives the radar signals reflected in the detection area. The lens device has a first lens for the transmitted radar signals and a second lens for the reflected radar signals. The second lens is arranged substantially directly adjacent to the first lens in a direction of a length extension in a top view. The first lens and the second lens are designed so that a ratio between the length extension and a width extension of the first directivity of the radar signals or a second directivity of the radar signals is influenceable, i.e., the radar signals with the first directivity are convertible into radar signals with the second directivity.

### CROSS REFERENCE TO PRIOR APPLICATIONS

Priority is claimed to European Patent Application No. EP 23196947.8, filed Sep. 12, 2023. The entire disclosure of said application is incorporated by reference herein.

### FIELD

The present invention relates to a radar sensor for determining the distance of an object.

### BACKGROUND

Radar sensors for determining the distance of an object within a detection area extending in an a from the radar sensor are generally known from the prior art. EP 3 534 173 B1 describes, for example, a housing arrangement of such a radar sensor.

This generic radar sensor comprises a transmitter module with an antenna which is formed of a patch array to generate radar radiation with a first directivity, and a receiver module also comprising a patch array antenna for a simultaneous reception of reflected radar radiation.

To improve gain and directivity of the antenna, the known radar sensor still includes a lens device which is formed by a converging lens used by both the transmitter and receiver modules.

For some applications, however, it is advantageous if the minimum distance at which a reliable detection of objects is possible is reduced.

Radar sensors include a blind zone that extends between the radar sensor and the object to be detected. If an object is located within the blind zone, i.e., the minimum distance between the radar sensor and the object to be detected is not maintained, a reliable detection of the object is not possible.

The blind zone of a radar sensor is substantially determined by two effects: First, crosstalk of the transmitted radar radiation occurs at the inner surface of the lens device, resulting in adverse reflections that then strike the receiver module and adversely affect the signal-to-noise ratio. On the other hand, the reception power of the reflected radar radiation and the radar radiation detected by the receiver module must be sufficiently high, which is only provided with a suitable superimposition of the transmitter directional characteristic of the transmitted radar radiation and the receiver directional characteristic of the reflected and/or received radar radiation.

The realization of the lens device by a single converging lens also leads to squinting, which is caused by the transverse offset between the respective patch array antenna and the apex of the single radar lens, which has a negative effect on radar sensors.

### SUMMARY

An aspect of the present invention is to overcome the disadvantages known from the prior art. An aspect of the present invention is in particular to provide a radar sensor with a small blind range to reliably detect objects with a small distance within a detection area.

In an embodiment, the present invention provides a radar sensor for determining a distance of an object in a detection area. The radar sensor includes a transmitter module, a receiver module, and a lens device. The transmitter module comprises a transmitter-side patch array antenna having a first directivity. The transmitter module is configured to transmit radar signals with the first directivity. The receiver module comprises a receiver-side patch array antenna having a first directivity. The receiver module is configured to receive the radar signals which are reflected in the detection area. The lens device is arranged in a beam path of the transmitted radar signals and of the reflected radar signals opposite to the transmitter module and to the receiver module. The lens device comprises a first lens for the transmitted radar signals and a second lens for the reflected radar signals. The transmitter-side patch array antenna and the receiver-side patch array antenna are each configured so that the respective first directivity comprises, in a sectional plane running vertical with respect to a propagation direction of the transmitted or reflected radar signals, a length extension and a width extension which runs orthogonal to the length extension, the length extension being smaller than the width extension. The second lens is arranged substantially directly adjacent to the first lens in a direction of the length extension in a top view. The first lens and the second lens are designed so that a ratio between the length extension and the width extension of the first directivity of the radar signals or a second directivity of the radar signals is influenceable so that the radar signals with the first directivity, and thus with the length extension which is smaller than the width extension, is convertible into radar signals with the second directivity, and thus with a length extension which is larger than a width extension, and/or vice versa.

### BRIEF DESCRIPTION OF THE DRAWINGS

The present invention is described in greater detail below on the basis of embodiments and of the drawings in which:

FIG. 1 shows a first schematic view of a radar sensor according to the present invention in accordance with a first exemplary embodiment;

FIG. 2 shows a second schematic view of a radar sensor according to the present invention in accordance with a first exemplary embodiment;

FIG. 3 shows a third schematic view of a radar sensor according to the present invention in accordance with a first exemplary embodiment;

FIG. 4 shows a fourth schematic view of a radar sensor according to the present invention in accordance with a first exemplary embodiment;

FIG. 5 shows a schematic side view of the first lens in the direction of the length extension as well as in the direction of the width extension;

FIG. 6 shows a schematic side view of the second lens in the direction of the length extension as well as in the direction of the width extension;

FIG. 7 shows a schematic functional diagram of the radar sensor of FIGS. 1-4;

FIG. 8 shows a schematic representation in a top view of the radar sensor according to the present invention in accordance with optional embodiments;

FIG. 9 shows a schematic representation in a top view of the radar sensor according to the present invention in accordance with optional embodiments;

FIG. 10 shows a schematic representation in a top view of the radar sensor according to the present invention in accordance with optional embodiments;

FIG. 11 shows a schematic representation in a top view of the radar sensor according to the present invention in accordance with optional embodiments;

FIG. 12 shows a highly schematic top view of a vehicle comprising a radar sensor according to the present invention in accordance with a first mounting option; and

FIG. 13 shows a highly schematic top view of a vehicle comprising a radar sensor according to the present invention in accordance with a second mounting option.

### DETAILED DESCRIPTION

The radar sensor according to the present invention is designed for determining the distance of objects in a detection area.

The radar sensor can, for example, be based on the frequency modulated continuous wave method (FMCW). The emitted radar signals can, for example, serve as a carrier signal whose frequency is varied in a defined range. The radar sensor is at the same time set up to detect reflected radar signals, with the distance and/or speed of the objects located within the detection area being determined by evaluating the reflected radiation in relation to the original carrier signal.

The radar sensor can, for example, be designed as a close-range radar sensor, in particular with a blind range smaller than 80 mm.

The radar sensor according to the present invention comprises a transmitter module which has a transmitter-side patch array antenna with a first directivity. The transmitter module is designed and/or configured to emit radar signals with the first directivity.

The radar signals with the first directivity comprise a length extension Ly and a width extension Bx extending orthogonally and/or at right angles thereto in a sectional plane which is aligned transversely and/or at right angles to the direction of propagation of the transmitted radar signals, whereby the length extension Ly is smaller than the width extension Bx.

In other words, the radar signals with the first directivity comprise an elongated and/or oval and/or asymmetric main beam.

The radar sensor according to the present invention also comprises a receiver module comprising a receiver-side patch array antenna also having a first directivity.

The receiver module is configured and/or designed to detect radar signals that have been reflected, in particular in the detection area of the sensor unit. The patch array antenna on the receiving side also comprises a first directivity and is thus designed and/or set up to detect the radar signals with the first directivity.

The patch array antenna on the transmitting side and the patch array antenna on the receiving side are in particularly positioned adjacent to each other in the direction of the length extension Ly.

It is noted that the first directivity of the patch array antenna on the transmit side need not match the first directivity of the patch array antenna on the receive side.

In other words, the first lens is designed so that the ratio between the length extension Ly and the width extension Bx of the first directivity of the radar signals is influenceable or adjusted so that the radar signals with the first directivity and thus with the length extension Ly, which is smaller than the width extension Bx, is converted into radar signals with the second directivity and thus with a length extension Ly, which is larger than the width extension Bx, and/or that the second lens is designed so that the ratio between the length extension Ly and the width extension Bx of the second directivity of the radar signals is influenceable or adjusted so that the radar signals with the second directivity and thus with the length extension Ly, which is larger than the width extension Bx, is converted into radar signals with the first directivity and thus with a length extension Ly, which is smaller than the width extension Bx.

The radar sensor according to the present invention also comprises a lens device which is positioned and/or arranged relative to the transmitter and receiver modules so that substantially all of the transmitted and reflected radar signals meet the lens device.

According to the present invention, the lens device is provided by a first lens for the emitted radar signals and by a second lens for the radar signals reflected in the detection area. The first and second lenses are directly adjacent with respect to the length extension Ly of the radar signals generated. In other words, the first and the second lens are positioned substantially immediately adjacent to each other in a top view in the direction of the length extension Ly and/or in a common plane and/or adjacent to each other.

In the context of the present invention, “substantially directly adjacent” means that the first lens and the second lens, which can, for example, each be formed as an independent converging lens, are each fully formed and directly merge into each other.

The arrangement of the first lens next to the second lens can, for example, be provided via a carrier unit and/or a housing arrangement. The relative position between the transmitter module and the receiver module and the first lens and the second lens is thereby advantageously defined. The position of the first lens relative to the second lens is thereby at the same time also determined.

The first and the second lens can, for example, be defined as a single piece and/or monolithically. Such a lens unit can advantageously be more easily positioned relative to the transmitter module and the receiver module.

In a first aspect of the present invention, the transmitter-side patch array antenna and the receiver-side patch array antenna are configured to generate and detect radar signals having the first directivity.

Radar signals with the first directivity comprise an asymmetric and/or elongated directivity, wherein the length extension Ly is smaller than the width extension Bx. It is noted in this regard that the length extension Ly of the transmitted radar signals and the length extension Ly of the reflected radar signals are aligned along a common direction.

According to another aspect of the present invention, the first lens and the second lens are immediately adjacent or directly adjacent in the direction of the length extension Ly. In accordance with the present invention, it is thus advantageous to firstly minimize crosstalk of the transmitted radar signals to the receiver module by reflection from the inner surface of the first lens and/or the second lens.

The present invention further provides that the first lens and the second lens are designed so that the ratio between the length extension Ly and the width extension Bx of the first or a second directivity of the radar signals are influenced so that the radar signals with the first directivity and thus with the length extension Ly, which is smaller than the width extension Bx, are transformed into radar signals with the second directivity and thus with a length extension Ly, which is larger than the width extension Bx and/or that the radar signals with the second directivity and thus with the length extension Ly, which is larger than the width extension Bx, are transformed into radar signals with the first directivity and thus with a length extension Ly, which is smaller than the width extension Bx.

In other words, the patch array antenna of the transmitter module and the patch array antenna of the receiver module are configured so that radar signals with a first directivity can be emitted and/or received.

Radar signals with the first directivity comprise, in a sectional plane spaced from the transmitter and/or receiver module, a directivity and/or a main beam which is asymmetrical and/or oval with respect to a first length extension and a first width extension, the first length extension being smaller than the first width extension.

Radar signals with the second directivity, which is generated by the first and/or second lens when radar signals with the first directivity are incident, comprise a directivity and/or a main beam in a sectional plane at a distance from the transmitter and/or receiver module, which main beam is also asymmetrical and/or oval with respect to a second length extension and a second width extension, the second length extension being greater than the second width extension.

According to the present invention, objects in the detection area can be detected at a small and/or low minimum distance by the radar signals with the second directivity, since the larger, in particular second, length extension for a defined distance results in a larger overlapping range compared to the smaller, in particular first, length extension between the emitted and reflected radar signals. In other words, the minimum distance can as a result be reduced by the radar sensor according to the present invention.

The transmitter-side and/or receiver-side patch array antenna can, for example, comprise in each case at least two branches with in each case at least three patches connected serially and/or in series, wherein, in a top view, the at least two branches of the respective patch array antenna, which in particular run and/or are aligned in a common antenna plane, are aligned parallel and/or mirror-symmetrically along a first mirror axis S1, which in the top view runs along the direction of the length extension.

Such an embodiment of the respective patch array antenna advantageously enables the negative effects on the receiver module, in particular due to crosstalk, to be additionally minimized.

In an embodiment of the present invention, the transmitter module and the receiver module can, for example, be arranged relative to each other so that the at least two branches of the transmitter module are aligned mirror-symmetrically to the at least two branches of the receiver module in a top view with respect to a second mirror axis S2 running in the direction of the width extension Bx, the first mirror axis S1 and the second mirror axis S2 running orthogonally to each other.

Such a design of the transmitter module and the receiver module can additionally reduce the crosstalk and other negative interactions between the transmitter module and the receiver module, and thus provide a radar sensor with the smallest possible blind area.

The number of patches of one of the at least two branches of the transmitter module and/or the number of patches of one of the at least two branches of the receiver module can, for example, exceed the number of branches of the respective patch array antenna by a quantity unit of at least 1 to generate the radar signals with the first directivity.

The number of patches per branch of the transmitter module and/or receiver module can, for example, be odd and/or the number of branches per transmitter module and/or receiver module can, for example, be even.

In an embodiment of the radar sensor according to the present invention, the at least two branches of the transmitter module and/or the at least two branches of the receiver module can, for example, each be defined as a series-fed array.

In an embodiment of the present invention, the at least two branches can, for example, each be configured to comprise at least one, optionally exactly one, tapered patch at their ends in order to adapt the beam angle, in particular the radiation pattern with respect to the length extension Ly, in accordance with the present invention.

It is further planned in this context that the tapered patch comprises, with respect to an untampered patch or normal patch in a top view in the direction of the width extension, a patch width of less than 90%, for example, less than 80%, for example, less than 70%, and for example, less than 60%.

The directivity of the generated radar signals can advantageously be additionally optimized.

The transmitter module, in particular the transmitter module and the receiver module, can, for example, comprise a power divider. The power divider is symmetrically designed so that the power can be divided evenly and/or symmetrically between the individual branches of the transmitter module, in particular the transmitter module and the receiver module.

The power divider can, for example, be designed in stages, with a power reduction by half in each stage.

In an embodiment of the radar sensor according to the present invention, the first and/or the second lens can, for example, comprise a diameter of less than 60 mm, for example, less than 40 mm, for example, less than 30 mm, and for example, less than 22 mm.

The first lens and/or the second lens can additionally or alternatively be formed of a dielectric material and/or at least comprises such a material.

The first lens and/or the second lens can additionally or alternatively be formed in a planoconvex design.

It is noted that the first lens also functions as a transmitting lens and may be so called. It is further noted that the second lens is designable as a receiving lens and/or functions in such a manner.

The radar sensor can, for example, comprise a blind area which is smaller than 300 mm, for example, smaller than 200 mm, for example, smaller than 100 mm, and for example, smaller than 80 mm.

The present invention also provides a vehicle or an attachment for a vehicle, for example, an agricultural utility vehicle or an attachment for an agricultural utility vehicle, for example, a tractor or an attachment for a tractor, for example, a combine harvester or an attachment for a combine harvester, for example, a forage harvester or an attachment for a forage harvester, comprising a radar sensor according to the present invention, wherein the radar sensor is arranged on the vehicle either in a first mounting option or in a second mounting option.

In the first mounting variant or mounting option, the radar sensor according to the present invention is arranged on the vehicle or on the attachment for a vehicle transversely and/or vertically to the direction of motion Fr so that the width extension of the first and/or second directivity of the radar signals is aligned in the direction and/or along the direction of motion Fr.

In the second mounting variant or mounting option, the radar sensor according to the present invention is arranged on the vehicle or on the attachment for a vehicle longitudinally and/or parallel to the direction of motion Fr so that the length extension Ly of the first and/or second directivity of the radar signals is aligned in the direction and/or along the direction of motion Fr.

The influence of disturbing objects, such as mounted components of the vehicle, which are not to be detected, can advantageously thus be optimized.

The present invention is explained in greater detail below with reference to the drawings. The combination of features shown by way of example can be supplemented by further features as set forth above depending on which properties of the radar sensor are required for a particular application.

In the drawings, elements of the same function and/or the same structure are designated by the same reference sign.

The radar sensor 1 according to the present invention comprises a transmitter module 3, which has a transmitter-side patch array antenna 4 with a first directivity. The transmitter module 3 is designed to transmit radar signals with the first directivity.

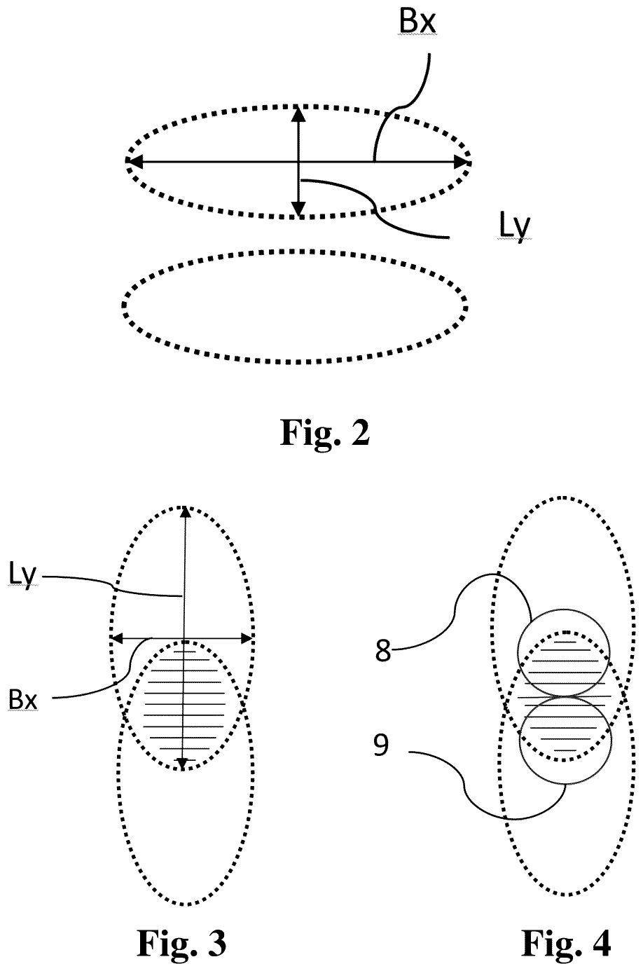

It is here pointed out that radar signals with the first directivity comprise a length extension Ly and a width extension Bx extending orthogonally thereto in a sectional plane spaced from the transmitter module 3 along the propagation direction of the radar signals, whereas the length extension Ly is smaller than the width extension Bx (see FIG. 2).

The radar sensor 1 according to the present invention also comprises a receiver module 5 which has a patch array antenna 6 on the receiving side with a first directivity.

The receiver module 5 is designed and/or optimized for receiving reflected radar signals with the first directivity.

The transmitter module 3 and the receiver module 5 are arranged in a common plane and/or electrically connected to a control and/or an evaluation device 16.

In top view from above, the transmitter module 3, the receiver module 5, and the lens device 7 are arranged in the beam path of the transmitted and received radar signals.

In the context of the present invention, the lens device 7 is formed by a first lens 8 for the transmitted radar signals and a second lens 9 for the reflected radar signals, shown herein by dashed circles to represent the outer contour of the first lens 8 and the second lens 9.

The first lens 8 and the second lens 9 are also positioned in a common plane, which in the shown embodiment is oriented above and parallel to the image plane.

The present invention provides that the first lens 8 and the second lens 9 are substantially directly adjacent to each other in a top view in the direction of length extension Ly.

In other words, the first lens 8 is positioned mirror-symmetrically with respect to the second lens 9 with respect to a second mirror axis S2, whereas the second mirror axis S2 is oriented in the direction of the width extension Bx of the radar signals that can be generated and extends tangentially to the outer contour of the first lens 8 as well as tangentially to the outer contour of the second lens 9.

In other words, the first lens 8 is formed mirror-symmetrically to the first mirror axis S1 and the second lens 9 is formed mirror-symmetrically to the first mirror axis S1.

The first lens 8 is arranged and/or designed so that, when radar signals with the first directivity are incident and/or received, the ratio between the length extension Ly and the width extension Bx is adjusted so that the radar signals with the first directivity, which has a length extension Ly smaller than the width extension Bx, are converted and/or turned into radar signals with the second directivity, whereas the radar signals with the second directivity having a length extension Ly which is larger than the width extension Bx.

The second lens 9 is arranged and/or designed so that, when radar signals with the second directivity are incident and/or received, the ratio between the length extension Ly and the width extension Bx is adjusted so that the radar signals with the second directivity, which has a length extension Ly greater than the width extension Bx, are converted and/or turned into radar signals with the first directivity, whereas the radar signals with the first directivity having a length extension Ly which is smaller than the width extension Bx.

FIG. 2 shows the configuration of the transmitted and reflected radar signals with the first directivity in a first sectional plane.

The first sectional plane is located between the transmitter module 3 and the receiver module 5 and the first lens 8 and the second lens 9. The first sectional plane is also oriented transversely to the direction of propagation of the radar signals.

Within the first sectional plane, the radar signals with the first directivity comprise a non-uniform configuration or main loop and/or asymmetrical configuration or main loop and/or oval configuration or main loop, wherein the length extension Ly is smaller than the width extension Bx.

The transmitter module 3 and the receiver module 5 are additionally positioned adjacent to one another in the direction of the length extension Ly and the first lens 8 and the second lens 9 are positioned directly adjacent to one another in the direction of the length extension.

FIG. 3 shows in a similar strongly schematized view the transmitted and reflected radar signals with the second directivity in a common second sectional plane.

The second sectional plane extends in the region between the first lens 8 and the second lens 9 and an object to be detected. The sectional plane is also oriented transversely to the direction of propagation of the radar signals.

Within the second sectional plane, the radar signals with the second directivity comprise a non-uniform configuration and/or asymmetrical configuration and/or oval configuration or main loop, whereby the length extension is greater than the width extension Bx.

Via the first lens 8 and the second lens 9, the directivity of the radar signals is changed so that radar signals with a large width extension and a small length extension are converted into radar signals with a small width extension and a large length extension and vice versa.

The present invention advantageously enables a radar sensor 1 to be provided which comprises minimal crosstalk due to the internal reflection of the transmitted radar signals onto the receiver module 5 and, due to the large length extension Ly and the corresponding relative positioning of the transmitter module 3 and receiver module 5, has a wide overlapping area and, as a result, comprises a small blind area (compare the shaded area in FIG. 3).

FIG. 4 shows a further highly schematized representation, whereby in contrast to the representation known from FIG. 3, the outer contours of the first lens 8 and the second lens 9, which are directly adjacent along the longitudinal direction Ly, are now additionally shown.

FIG. 5 shows the first lens 8 and second lens 9 according to the present invention in a sectional view in the direction of the length extension Ly, whereas the second lens 9 is completely covered behind the first lens 8.

The first lens 8 and the second lens 9 are designed identically in the present case, i.e., they each comprise a plano-convex design and the same diameter of, for example, 300 mm.

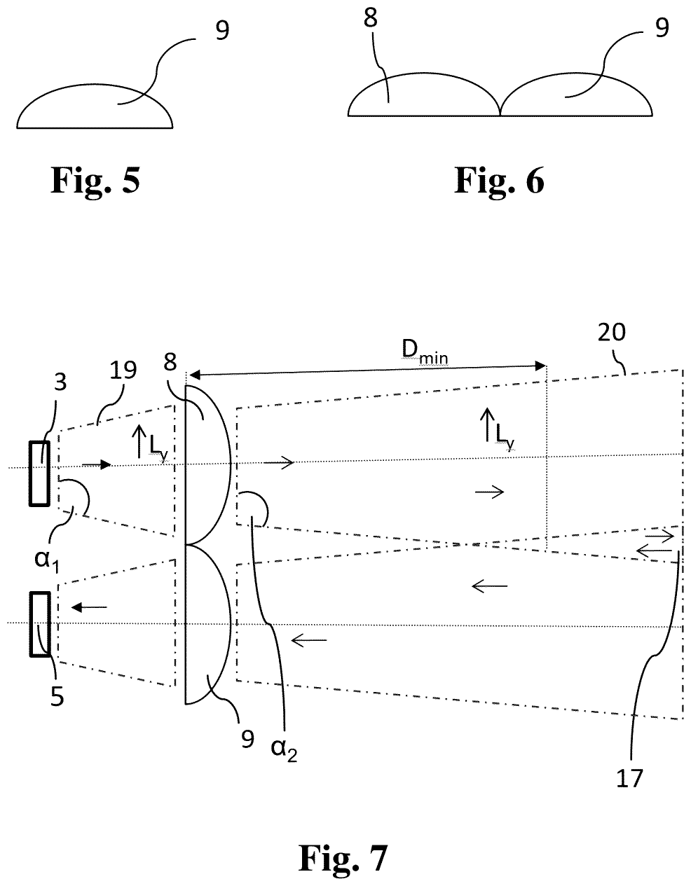

FIG. 6 shows the first lens 8 and the second lens 9 in a sectional view in the direction of the width extension By. This view shows that the first lens 8 and the second lens 9 are directly adjacent in the direction of the length extension Ly, but do not comprise an overlapping and/or common border region.

FIG. 7 shows a further schematized embodiment in a side view to further explain the functionality of the radar sensor 1 according to the present invention.

FIG. 7 shows the transmitter module 3, which is designed to transmit the radar signals with the first directivity. The direction of propagation of the radar signals with the first directivity is symbolically shown in FIG. 7 via first arrows.

The length extension Ly of the radar signals with the first directivity, which widens as the path is covered, is also shown schematically by a first equal-sided trapezoid 19 and the length extension Ly of the radar signals with the second directivity is shown schematically by a second equal-sided trapezoid 20.

FIG. 7 also shows that the emitted and reflected radar signals with the second directivity are superimposed in a central region, which defines the detection area 17 of the sensor unit 1.

It can furthermore be seen from FIG. 7 that the propagation angle di in front of the first lens 8 is larger than the propagation angle α₂ after the first lens 8. In other words, the transmitter-side patch array antenna 4 emits the radar signals at a larger propagation angle α₁ than the beam path generated by the first lens 8 having the propagation angle α₂.

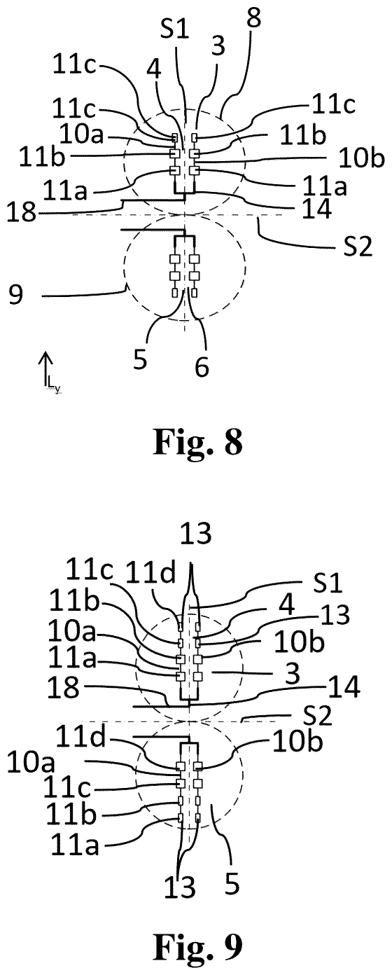

FIGS. 8-11 show the concrete structure of the transmitter module 3 and the receiver module 5 and of the first lens and the second lens 9 of the radar sensor 1 according to the present invention for various examples of embodiments in a top view.

It should thereby be stated that in all embodiments according to the present invention, the transmitter-side patch array antenna 4 and the receiver-side patch array antenna 6 each comprise at least two branches 10a-d, each having at least three serially connected patches 11a-d.

It should thereby also be stated that, in the top view, the at least two branches 10a-d of the respective patch array antenna 4, 6 are aligned parallel and/or mirror-symmetrically with respect to each other with respect to a first mirror axis S1, whereas this first mirror axis S1 extends along the length extension Ly in the top view.

It is further stated that in all embodiments, the transmitter module 3 and the receiver module 5 are arranged relative to each other so that the at least two branches 10a-d of the transmitter module 3 are aligned mirror-symmetrically regarding the at least two branches 10a-d of the receiver module 5 in top view with respect to a second mirror axis S2 extending in the direction of the width extension Bx.

It is also stated that the first mirror axis S1 and the second mirror axis S2 are aligned orthogonally to each other.

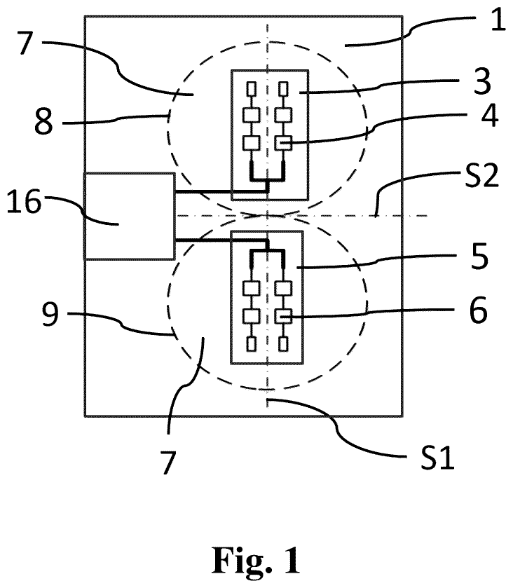

The embodiment according to FIG. 8 was previously described in the embodiment according to FIG. 1.

The transmitter module 3 comprises a patch array antenna 4 with two branches 10a/b, whereas every branch 10a/b comprises three serially connected patches 11a-c.

The two branches 10a/b are operatively connected to a common power path 18 via a balanced power divider 14.

The last patch 11c at the free end of the respective branch 10a/b is designed as a tapered patch 13. This advantageously influences the design of the first directivity of the radar sensor 1 according to the present invention.

It can moreover be seen from the embodiment that the first branch 10a and the second branch 10b are in parallel. The second branch 10b is also formed mirror-symmetrically with respect to the first mirror axis S1, wherein this first mirror axis S1 extends in the direction of the length extension Ly in the top view.

The outer contour of the first lens 8 is also indicated by a dashed circle.

The first lens 8 is directly located toward the second lens 9, which cooperates with the receiver module 5, in the direction of the length extension Ly. In other words, the first lens 8 and the second lens 9 are arranged in a mirror symmetrical manner with respect to a second mirror axis S2.

The receiver module 5 is also configured identically to the transmitter module 3 and is oriented so that the first and second branches 10a/b of the receiver module 5 are in mirror symmetry with respect to the second mirror axis S2 with reference to the first and second branches 10a/b of the transmitter module 3.

The embodiment according to FIG. 9 also comprises a transmitter module 3 with a patch array antenna 4 according to the present invention with a first branch 10a and a second branch 10b.

The first branch 10a comprises four patches 11a-d, each connected in series.

The last two patches 11c, 11d, which form the free end of the branch 10a, are each formed as tapered patches 13.

The second branch 10b is designed identically and mirror-symmetrically to the first branch 10a, with the first mirror axis S1 extending in the direction of the length extension Ly.

The first and second branches 10a/b are supplied with electrical energy from a common power path 18 in equal proportions via a balanced power divider 14 which is formed at a first end of the first and second branches 10a/b.

The receiver module 5 is designed identically and mirror symmetrical to the transmitter module 3 with respect to the second mirror axis S2, whereby the second mirror axis S2 runs in the direction of the width extension Bx.

The receiver module 5 therefore also comprises two branches 10a/b, each having four patches 11a-d, the two branches 10a/b being designed to be mirror-symmetrical with respect to the first mirror axis S1.

The first lens 8 and the second lens 9 are also each designed and/or arranged mirror-symmetrically with respect to the first mirror axis S1.

The first lens 8 is also designed and/or arranged mirror-symmetrical with respect to the second mirror axis S2 with respect to the second lens 9 and/or vice versa.

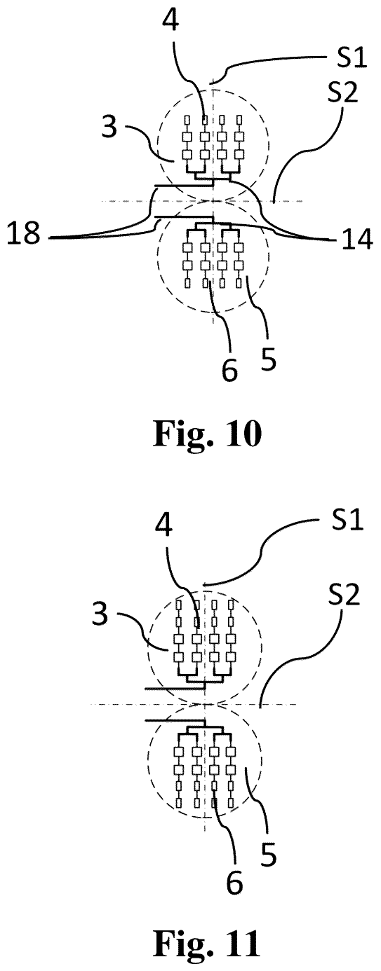

With respect to the embodiments of FIG. 10 and FIG. 11, only the differences with respect to the embodiments of FIGS. 8 and 9 are explained below.

All descriptions apply therefore also to the following embodiments.

The transmitter module 3 and the receiver module 5 in the described embodiment according to FIG. 10 comprises four branches 10a-d (which are not numbered) with each three patches 11a-c (which are also not numbered).

The free end of the respective branches 10a-d is defined by a tapped patch 13 (which is not numbered), each branch 10a-d comprising only a single tapped patch 13. On the input side, the individual branches 10a-d are connected to the common power path 18 via a balanced power divider 14, implementing a two-stage divider with line doubling and power halving respectively.

The transmitter module 3 and the receiver module 5 according to the embodiment of FIG. 11 also comprises four branches 10a-d (which are not numbered) each with four patches 11a-d (which are not numbered). Each branch 10a-d comprises two taped patches 13 (which are not numbered) forming the last two patches in the respective branch 10a-d.

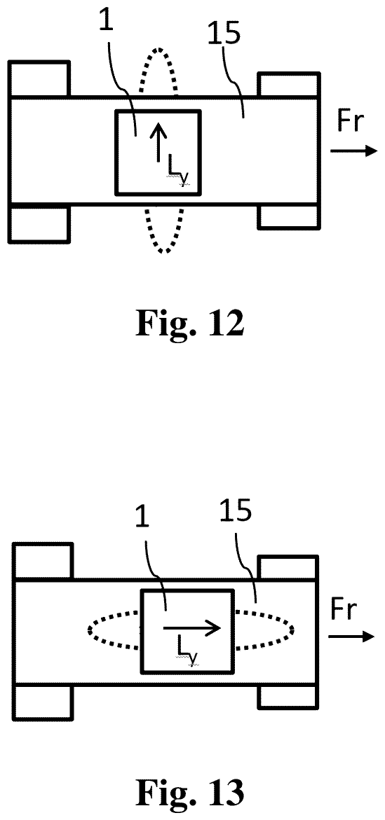

FIGS. 12 and 13 show a highly schematized representation of a vehicle 15 comprising a radar sensor 1 according to the present invention.

The vehicle 15, which in the present case is designed as a tractor, moves along the direction of motion Fr, for example, at a constant speed.

In FIG. 12, the radar sensor 1 according to the present invention is arranged on the vehicle 15 transversely to the direction of motion Fr in accordance with a first mounting option.

The width extension Bx of the first or second directivity is advantageously thus aligned in the direction of motion Fr.

In other words, the length extension Ly of the first and/or second directivity is aligned transversely or at right angles to the direction of travel Fr, thus minimizing the negative influence of add-on parts of the tractor which are detected as interfering objects by the radar sensor 1 according to the present invention.

In FIG. 13, the sensor unit 1 according to the present invention is mounted on the vehicle 15 according to a second mounting option, whereby in this second mounting option, the length extension of the radar signals with the first or second directivity is aligned in the direction of motion Fr.

The choice of the mounting option makes it possible for protruding metal parts, for example, from an add-on tool, not to protrude into the detection range of the radar sensor 1 according to the present invention, which would otherwise have a negative effect on the distance determination via the radar sensor 1 according to the present invention due to an interaction.

The present invention thus provides for the detection range of radar sensors to be optimized in a surprisingly simple manner via a smart interaction of the essential components so that a radar sensor with a small blind zone is provided compared to previously described radar sensors.

The present invention is not limited to embodiments described herein; reference should be had to the appended claims. All combinations of at least two of the features described in the description, the claims and/or in the drawings thereby fall within the scope of the present invention.

### LIST OF REFERENCE CHARACTERS

1 Radar sensor
3 Transmitter module
4 Patch array antenna/Transmitter-side patch array antenna
5 Receiver module
6 Patch array antenna/Receiver-side patch array antenna
7 Lens device
8 First lens
9 Second lens
10a First branch
10b Second branch
11a Patch
11b Patch
11c Patch
11d Patch
13 Tapered patch
14 Balanced power divider
15 Vehicle
16 Evaluation device
17 Detection area
18 Common power path
19 First equal-sided trapezoid
20 Second equal-sided trapezoid
α₁ Propagation angle in front of first lens 8
α₂ Propagation angle behind first lens 8
Bx Width extension
Dₘᵢₙ Minimum distance
Fr Direction of motion
Ly Length extension
S1 First mirror axis
S2 Second mirror axis

What is claimed is:

1. A radar sensor for determining a distance of an object in a detection area, the radar sensor comprising:
a transmitter module which comprises a transmitter-side patch array antenna having a first directivity, the transmitter module being configured to transmit radar signals with the first directivity;
a receiver module which comprises a receiver-side patch array antenna having a first directivity, the receiver module being configured to receive the radar signals which are reflected in the detection area; and
a lens device arranged in a beam path of the transmitted radar signals and of the reflected radar signals opposite to the transmitter module and to the receiver module, the lens device comprising a first lens for the transmitted radar signals and a second lens for the reflected radar signals,
wherein,
the transmitter-side patch array antenna and the receiver-side patch array antenna are each configured so that the respective first directivity comprises, in a sectional plane running vertical with respect to a propagation direction of the transmitted or reflected radar signals, a length extension and a width extension which runs orthogonal to the length extension, the length extension being smaller than the width extension,
the second lens is arranged substantially directly adjacent to the first lens in a direction of the length extension in a top view, and
the first lens and the second lens are designed so that a ratio between the length extension and the width extension of the first directivity of the radar signals or a second directivity of the radar signals is influenceable so that the radar signals with the first directivity, and thus with the length extension which is smaller than the width extension, is convertible into radar signals with the second directivity, and thus with a length extension which is larger than a width extension, and/or vice versa.

2. The radar sensor as recited in claim 1, wherein the radar sensor is a short-range radar sensor.

3. The radar sensor as recited in claim 1, wherein the length extension is smaller than the width extension so as to minimize a crosstalk of the transmitted radar signals on the receiver module.

4. The radar sensor as recited in claim 1, wherein
the transmitter-side patch array antenna and/or the receiver-side patch array antenna each comprises at least two branches, the at least two branches each comprising at least three serially connected patches, and
in the top view, the at least two branches of the transmitter-side patch array antenna and/or of the receiver-side patch array antenna are aligned parallel and/or mirror-symmetrically along a first mirror axis which, in the top view, runs in the direction of the length extension.

5. The radar sensor as recited in claim 4, wherein,
the transmitter module and the receiver module are arranged relative to one another so that, in the top view, the at least two branches of the transmitter-side patch array antenna are aligned mirror-symmetrically with respect to the at least two branches of the receiver-side patch array antenna with respect to a second mirror axis which runs in a direction of the width extension, and
the first mirror axis and the second mirror axis extend orthogonally with respect to each other.

6. The radar sensor as recited in claim 4, wherein,
a number of the at least three serially connected patches of one of the at least two branches of the transmitter-side patch array antenna is greater than a number of the at least two branches of the transmitter-side patch array antenna by at least 1 so as to emit the radar signals with the first directivity, and/or
a number of the at least three serially connected patches of one of the at least two branches of the receiver-side patch array antenna is greater than a number of the at least two branches of the receiver-side patch array antenna by at least 1 so as to receive the radar signals with the first directivity.

7. The radar sensor as recited in claim 6, wherein
the number of the at least three serially connected patches per branch of the transmitter-side patch array antenna is selected to be odd, and the number of the at least two branches for transmitter-side patch array antenna is selected to be even, and/or
the number of the at least three serially connected patches per branch of the receiver-side patch array antenna is selected to be odd, and the number of the at least two branches for the receiver-side patch array antenna is selected to be even.

8. The radar sensor as recited in claim 4, wherein the at least two branches of the transmitter-side patch array antenna and/or the at least two branches of receiver-side patch array antenna are each designed as a series-fed array (12).

9. The radar sensor as recited in claim 4, wherein the at least two branches each comprise, at an end thereof, at least one tapered patch (13) so as to reduce a beam angle.

10. The radar sensor as recited in claim 9, wherein the at least two branches each comprise, at the end thereof, exactly one tapered patch (13) so as to further reduce a radiation pattern with respect to the length extension.

11. The radar sensor as recited in claim 9, wherein the tapered patch (13), with respect to the at least three serially connected patches (11a-d), in the top view, comprises a patch width in the direction of the width extension of less than 90%.

12. The radar sensor as recited in claim 4, wherein,
at least one of the transmitter module and the receiver module comprises a power divider (14), and
the power divider (14) is configured symmetrically so that an output is divided uniformly between the at least two branches of the transmitter-side patch array antenna and/or of receiver-side patch array antenna.

13. The radar sensor as recited in claim 1, wherein,
the first lens and/or the second lens has a diameter of less than 60 mm, and/or
the first lens and/or the second lens comprises a dielectric material, and/or
the first lens and/or the second lens is of a planoconvex design.

14. The radar sensor as recited in claim 1, wherein the radar sensor comprises a blind area which is smaller than 300 mm.

15. A vehicle or a mounting device for a vehicle comprising:
the radar sensor as recited in claim 1,
wherein,
the radar sensor, in a first mounting option, is arranged on the vehicle transversely to a direction of motion so as to align the width extension of the directivity in a direction of the direction of motion, or
the radar sensor, in a second mounting option, is arranged longitudinally to the direction of motion so as to align the length extension of the directivity in a direction of the direction of motion.

16. The vehicle or the mounting device for a vehicle as recited in claim 12, wherein the vehicle is:
an agricultural utility vehicle or a mounting device for an agricultural utility vehicle, or
a tractor or a mounting device for a tractor, or
a combine harvester or a mounting device for a combine harvester, or
a forage harvester or mounting device for a forage harvester.
